(19) United States
(12) Patent Application Publication
(10) Pub. No.: US 2004/0145462 A1
(43) Pub. Date: Jul. 29, 2004

(54) Variable electronic display apparatus for a vehicle, and method of using same

(75) Inventor: Aaron Ambrose, Columbus, OH (US)

Correspondence Address: CARRIER BLACKMAN AND ASSOCIATES, 24101 NOVI ROAD, SUITE 100, NOVI, MI, 48375

(73) Assignee: Honda Giken Kogyo Kabushiki Kaisha, Tokyo (JP)

(21) Appl. No.: 10/353,290

(22) Filed: Jan. 29, 2003

(51) Int. Cl. B60Q 1/00

(52) U.S. Cl. 340/441; 340/691.6

(57) ABSTRACT

An apparatus for electronically displaying indicia in a selectively scrolling sequence within a vehicle, including a speed-dependent interrupt function. The apparatus may include a selecting member for selecting a data signal, a controller for controlling how information corresponding to the selected data signal is displayed, and a display member for displaying the information. The apparatus electronically displays the information as indicia on the display member, either in a scrolling sequence or statically. The controller includes a temporary interrupt function, which disengages the scrolling sequence and displays information in static position when the vehicle is traveling within a predetermined speed range. A method of displaying indicia on a display member includes a step of comparing vehicle speed to specified parameters, and a step of choosing whether or not to dynamically scroll data across a display field.

### FIELD OF THE INVENTION

The present invention relates to an electronic display apparatus for selectively displaying indicia in a vehicle. More particularly, the present invention relates to an electronic display apparatus for scrollably displaying indicia in a vehicle, in which the apparatus is adapted to communicate with a vehicle speed sensor, and includes a safety interrupt function to temporarily freeze the display when the vehicle is traveling within a predetermined speed range.

### BACKGROUND OF THE INVENTION

Within the automotive field, electronic components are widely used within vehicles to promote occupants' safety and convenience. By way of example, some vehicles include a console with an electronic display of vehicle information such as date, direction and outside temperature.

Other vehicles include navigation systems, satellite radio, such as XM, as well as a variety of electronically controlled vehicle condition-monitoring devices (e.g. tire pressure display), which are displayed at a location visible to the driver and/or passenger. Additionally, certain vehicle audio entertainment systems are capable of displaying not only the frequency of a given radio station, but also the call letters of the ration station, as well as other information such as the artist and title of the song being played, through the use of a scrolling text display enabled by a Radio Data System (“RDS”). Examples of some known devices which utilize the RDS technology are disclosed in U.S. Pat. Nos. 5,146,612 and 6,112,064.

Although electronically displayed information within a vehicle may be convenient to the driver and/or occupants, movably scrolling information displayed to a driver while the driver is operating the vehicle may give rise to a safety issue. The driver may become preoccupied with the display of scrolling information, rather than remaining attentive to the operation of the moving vehicle.

As a result, there exists a need for an apparatus which is capable of displaying information in a scrolling sequence, yet which is operable to safely interrupt the scrolling text display while a vehicle is in motion or when it is traveling within a predetermined speed range.

A limited number of electronic displays for displaying scrolling indicia including some kind of interrupt function have been developed. Some of the known devices for electronically displaying indicia which include an interrupt function are illustrated in U.S. Pat. Nos. 5,412,892; 5,548,828; 5,774,109; and 5,825,281.

While the aforementioned devices display scrolling indicia, a need still exists in the art for an improved electronic display apparatus capable of displaying scrolling indicia within a vehicle, including an interrupt function for temporarily disengaging the scrolling sequence when a vehicle is traveling within a predetermined speed range.

### SUMMARY OF THE INVENTION

The present invention has been developed to overcome limitations and disadvantages of the prior art, and to generally fulfill a need in the art for an electronic display apparatus that is capable of selectively scrolling indicia along a visual display screen within a vehicle when installed therein. The apparatus according to the present invention is operable to temporarily interrupt a scrolling text display when appropriate.

A scrolling display apparatus in accordance with a first embodiment of the present invention includes a selecting member for selecting information to be displayed, a display member including a screen for visually displaying indicia, and a controller for controlling the display of indicia on the display member. The display screen includes at least one display field for displaying the indicia.

The apparatus in the first embodiment is operable to receive a selected data signal from a data source. The data signal is selected by the operator or occupant of the vehicle, through contact with the selecting member. In response to the selected data signal, the controller activates the display member to display indicia corresponding to the selected data signal within a display field of the display member. The controller selectively engages a scrolling sequence to display the indicia while simultaneously monitoring information received from a vehicle's speed sensor. Upon receipt from the vehicle speed sensor that the vehicle is traveling outside of a predetermined speed range, the controller is operable to temporarily interrupt the scrolling sequence and to statically display selected indicia.

Accordingly, it is a feature of the present invention to provide an apparatus which is operable to display indicia to the occupants of a vehicle when installed therein. The indicia to be displayed may relate to numerous informational topics depending on the data source, including safety information regarding the operational status of a vehicle's components, navigational information, a radio station, or song information.

The present invention provides an apparatus which is operable to selectively display indicia in a scrolling sequence within a vehicle. Indicia may be displayed in a scrolling sequence in response to input from a vehicle occupant, or as a result of the indicia from a data signal exceeding the available space on a display screen, wherein the scrolling sequence is preferred to sequentially display all indicia. The present invention provides an apparatus which is operable to display indicia within a vehicle in a safe, static manner when the vehicle is traveling at certain rates of speed. To avoid distraction during the operation of a vehicle, the scrolling sequence of indicia is temporarily interrupted when the vehicle is traveling outside of a predetermined speed range, and the indicia are then displayed in a static position.

It is another feature of the invention to provide a method of displaying information to a vehicle driver, in which a scrolling display may be temporarily interrupted under certain predetermined conditions.

Other features and advantages of the invention will become apparent from the following detailed description which, in conjunction with the annexed drawings, discloses the presently preferred embodiments of the invention.

### BRIEF DESCRIPTION OF THE DRAWINGS

FIG. 1A is a block diagram of an electronic display apparatus in accordance with a first embodiment of the invention.

FIG. 1B is a simplified flow chart showing a sequence of steps in the operation of the apparatus of FIG. 1.

FIG. 2 is a series of sequential views of a scrolling sequence of indicia, as displayed on a display member of an apparatus according to the invention.

FIG. 3 is a block diagram of an electronic display apparatus in accordance with a second embodiment of the invention.

FIG. 4 is an environmental view of the apparatus of FIG. 3.

FIG. 5 is an illustration of the display member of the apparatus of FIGS. 3-4.

FIG. 6 is a block diagram of an electronic display apparatus in accordance with a third embodiment of the invention; and

FIG. 7 is an illustration of the display member of the apparatus of FIG. 6.

### DETAILED DESCRIPTION

First Embodiment

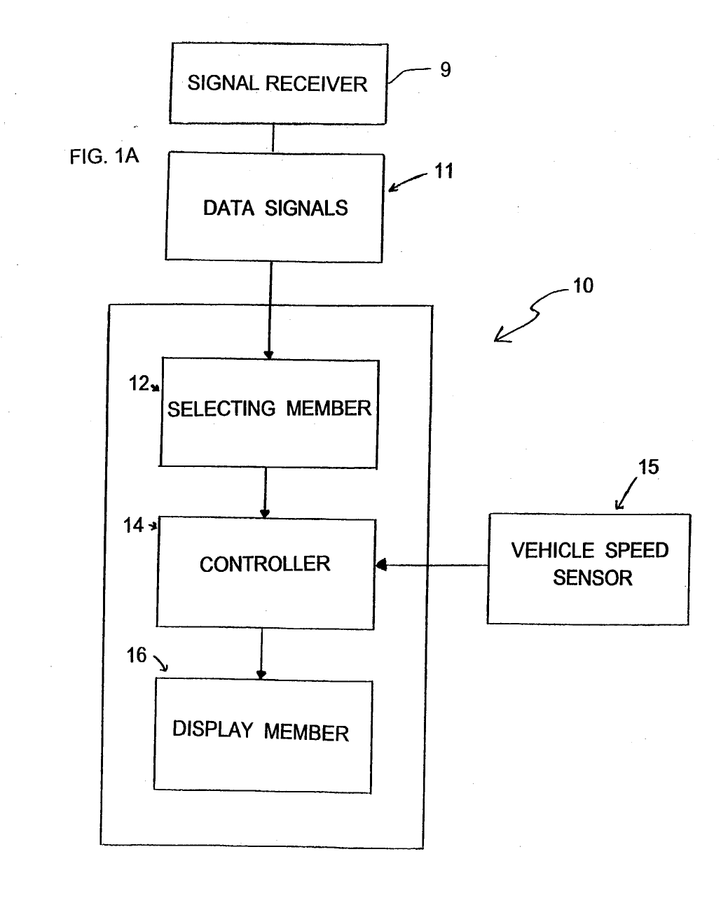

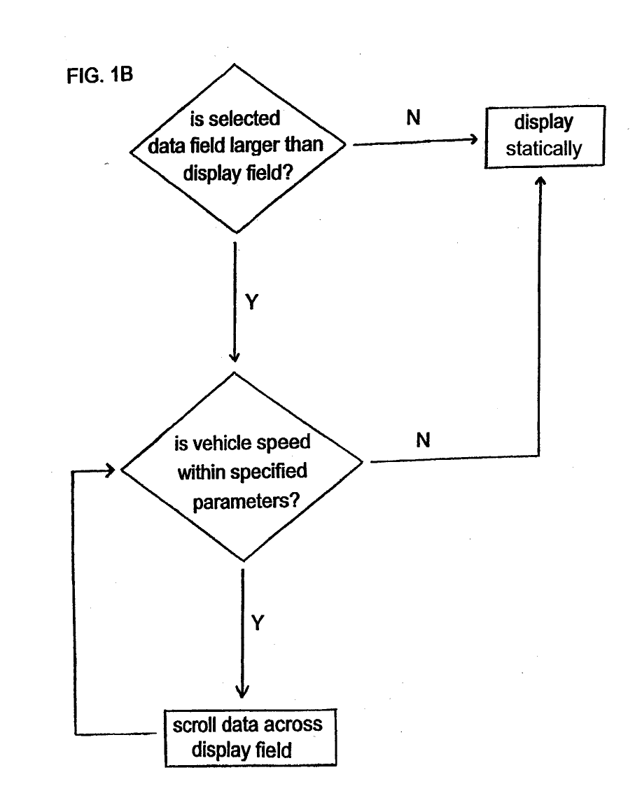

Referring to FIG. 1, an electronic display apparatus, according to a first embodiment of the invention, is shown generally at 10. The apparatus 10 electronically displays indicia to the occupants of a vehicle. The apparatus 10 generally includes a selecting member 12, a controller 14, and a display member 16.

The selecting member 12 may, for example, consist of a push-button or dial on an audio entertainment system, which cycles through receivable data signals 11. Such a selecting member may allow a user to choose, for example, a preferred radio station or an audio track on an audio compact disc (CD). Alternately, the selecting member 12 may be incorporated within the display member 16, where the display member 16 is a touch-screen display. The selecting member 12 may include an automated default selector such as, for example, an audio CD automatically progressing through the sequence of recorded material thereon.

The controller 14 may be associated with the vehicle's main computer, or may be independent. The controller 14 preferably includes a microprocessor, and the controller is in electronic communication with a vehicle speed sensor 15, which generates a signal corresponding to vehicle speed. Vehicle speed sensors are standard equipment on most late-model and new cars.

The display member 16 provides visual information relative to a selected data signal to a driver and/or occupants of a vehicle. The display member 16 may be a digital LED or liquid crystal display, or may alternatively be a touch-screen display. The display member includes a display field having a certain predetermined size or capacity for displaying data.

As shown in FIG. 1A, the apparatus 10 is installed in a vehicle, and in electronic communication with the vehicle's speed sensor 15, discussed elsewhere herein.

The apparatus 10 is also in contact with a signal receiver 9 for receiving data signals 11. The data signals 11 may include audio entertainment information, may include signals from a vehicle's main computer, (i.e. for displaying the status of a vehicle's components), or may include data from an external source such as a compact disc, MP3, radio station, OnStar® system, mobile phone, satellite radio, etc.

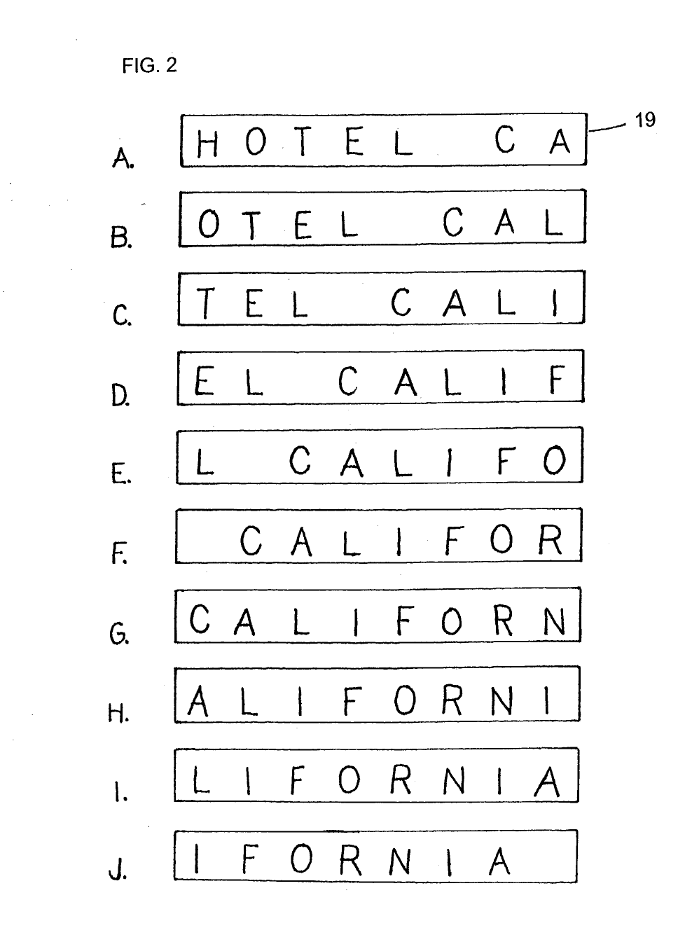

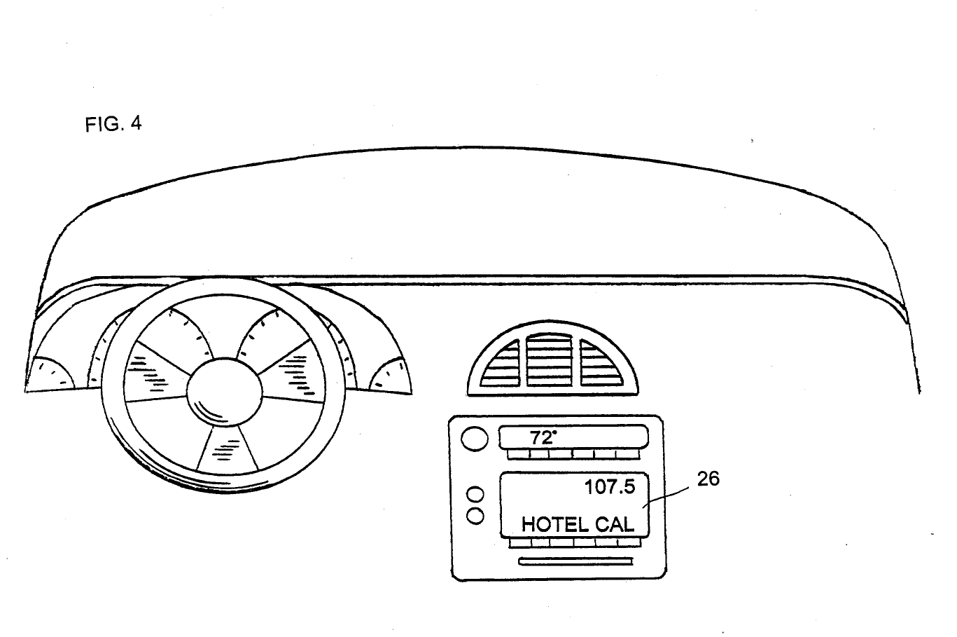

Further referring to FIG. 1A, the selecting member 12, upon receiving input from a vehicle occupant, transfers a selected data signal to the controller 14. For purposes of illustration, in the present discussion and FIGS. 2, 4 and 5 of the drawings, we will use a data signal representing a selection of the audio song “Hotel California”.

Upon receipt of the selected data signal, the controller 14 goes through a sequence of steps to determine how information corresponding to the data signal should be displayed by the display member. This sequence is summarized by the flow chart of FIG. 1B.

First, the controller 14 evaluates the size of the data field which will be required to display information corresponding to the selected data signal, and compares it to the size of the display member's display field 19. If the size of the data field is smaller than or equal to the size of the display field 19, then the information is displayed statically and the sequence ends.

However, if the size of the data field is larger than the size of the display field 19, the controller 14 reads an input signal from the vehicle speed sensor 15, and determines whether or not the vehicle speed is within specified parameters.

In one embodiment of the invention, the specified parameter may be exclusively zero miles per hour, meaning that the display will only be dynamically displayed when the vehicle is sitting still. In another, alternative embodiment of the invention, the specified parameter may be either zero miles per hour or a value within a specified range of speed such as, for example, between 40 and 70 miles per hour. This would allow for a scrolling display both when the vehicle is at rest and traveling on the highway at cruising speeds.

The specified parameters may depend on a specific application, and may therefore be programmable into the apparatus by the vehicle manufacturer.

If the vehicle speed is outside of the specified parameters, then data corresponding to the selected signal is displayed statically. This may be done by statically displaying only the first part of the data field, such as is shown in FIG. 2A. An alternative static display my be made by freezing the display in its instantaneous position at such time as the vehicle speed moves outside of the scrolling speed range. This may result in a display such as that shown in FIG. 2E, for example.

If the data field is larger than the display field, AND the vehicle speed is within the specified parameters, then the controller scrolls the data field across the display field of the display member 16, in a manner similar to that shown by the sequence of steps in FIGS. 2A-2J.

The controller may re-evaluate the vehicle speed every time a specified time increment passes, so that as soon as the vehicle speed goes outside of the specified parameters, the controller temporarily freezes the display. Such a specified time increment may be short, such as for example, one-hundredth of a second or less.

The controller 14 forwards information corresponding to the selected data signal to the display member 16, to be displayed in a manner consistent with the signal received from the vehicle speed sensor 15, i.e., whether in a normal scrolling sequence, a reduced speed scrolling sequence, or in a static position.

The vehicle speed sensor 15 provides the controller 14 with information about the instantaneous rate of speed at which the vehicle is traveling, and when the vehicle is standing still or is traveling in a predetermined speed range, the controller 14 selectively engages the scrolling sequence.

By way of a second example, when the vehicle is traveling less than a predetermined rate of speed, such as less than five miles per hour, the controller 14 may engage the scrolling sequence, to dynamically display the selected information. Conversely, when the vehicle is traveling within a predetermined speed range, such as above five and less than 40 miles per hour, the controller 14 may temporarily disengage the scrolling sequence and display selected portions of the information in a modified display, which may be a very slow scrolling display, or which may be a static display.

During the scrolling sequence the display member 16 would engage in scrolling information as shown in the entire sequence of FIGS. 2A-2J; however, should the scrolling sequence be temporarily disengaged at any time, the display member 16 could display the information as shown in FIG. 2A as a default. Alternatively, when the scrolling sequence is disengaged, the controller 14 may freeze the data display, with the current display information shown in a static position, rather than resetting to the first block of information.

An alternative type of ‘full line’ scrolling may be used, in which the display switches from that shown in FIG. 2A directly to the next portion of the text, as shown in FIG. 21. The display could alternate in this manner based on a preset time to display each screen. It could also vary depending on the length of the message, i.e., a message that fits on two screens could scroll via the ‘full line’ scrolling described above, while a longer message could scroll one letter at a time.

Still another alternative type of scrolling could slow the rate of scrolling to a very slow rate of movement (crawl speed), rather than a static display, when vehicle speed is sensed to be outside of the scrolling range, in order to be less distracting to a driver.

As additional alternatives, the scrolling sequence may cycle vertically rather than horizontally or from left to right (depending on the language in which the information is displayed).

Alternative embodiments of the apparatus 10 may include enabling the vehicle operator or occupant to manually set the rate of speed at which the controller 14 disengages the scrolling sequence. Further alternative embodiments of the present invention may provide an override switch or button for the vehicle operator or occupant, which allows the user to choose how the information is displayed.

Second Embodiment

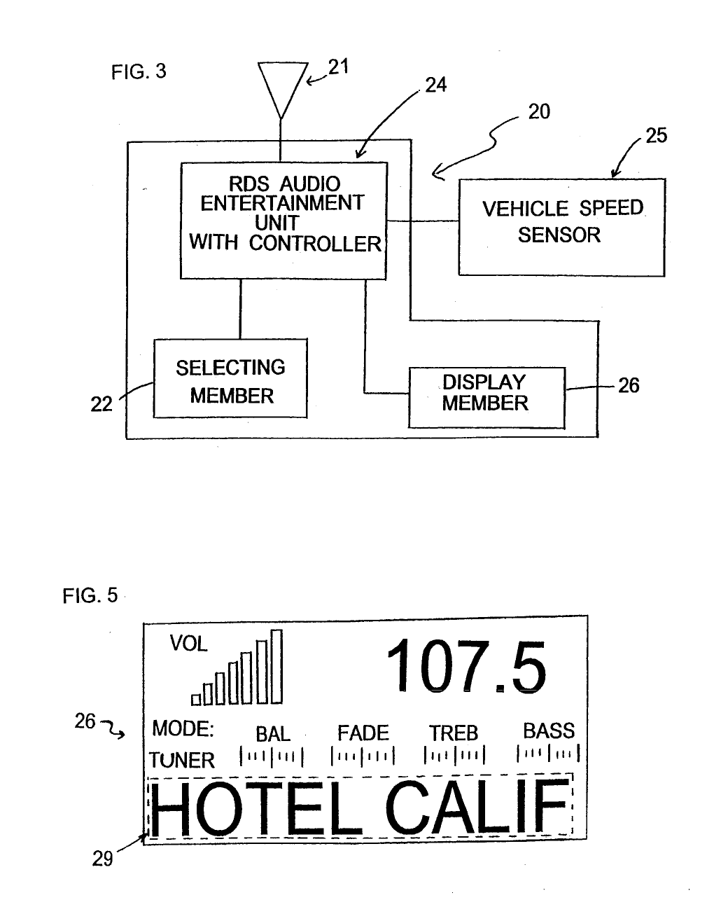

Referring to FIGS. 3-5, an electronic apparatus according to a second embodiment of the present invention is shown generally at 20. In this second embodiment, the apparatus 10 of the first embodiment has been coordinated with, and integrated into an audio entertainment system.

The apparatus 20 includes a Radio Data System (“RDS”) audio entertainment system, including a controller 24 which is in electronic communication with an antenna 21 for receiving data signals, a selecting member 22, and a display member 26.

The embodiment shown in FIGS. 3-5 operates in a manner similar to that of the embodiment shown in FIG. 1, and incorporates the alternative embodiments disclosed therewith. In the second embodiment hereof, however, the essential elements of the present invention disclosed in FIG. 1, namely the controller, selecting member and the display member, are integrated within an audio entertainment system. Accordingly, the selecting member 22 is integrated within the controls of the audio entertainment system.

The apparatus 20, in the embodiment of FIGS. 3-5, scrolls indicia corresponding to selected data across the display field 29, so long as signals from the vehicle speed sensor 25 indicate that vehicle speed is within the scrolling range.

Further, the display member 26 of the audio entertainment system includes a display field 29 to display information corresponding to a selected data signal. In cooperation with the audio entertainment system, the data signal may result from a number of sources received by the audio entertainment system such as a radio signal, satellite radio, compact disc, an MP3 or other audio sources containing data information.

Third Embodiment

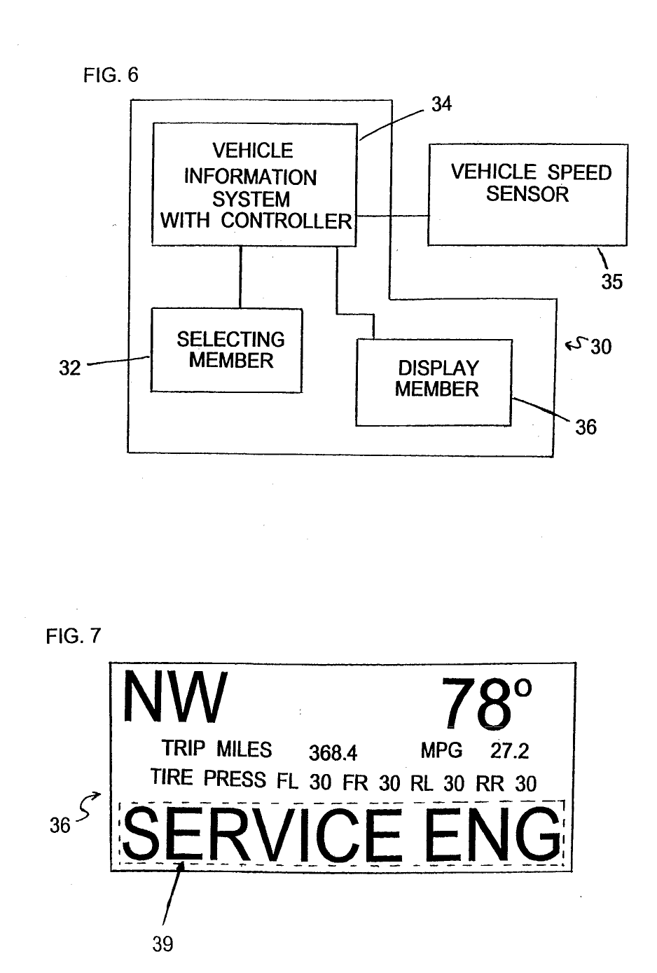

Referring to FIGS. 6 and 7, an electronic apparatus according to a third embodiment of the invention is shown generally at 30. The illustrated embodiment operates similar to that of the embodiment shown in FIG. 1, and incorporates the alternative embodiments disclosed therewith; however, the essential elements of the present invention disclosed in FIG. 1, namely the controller, selecting member and the display member, are integrated within a vehicle information system.

In the embodiment of FIGS. 6-7, the controller 34 is included within the main processing unit of the vehicle, and the selecting member 32 is integrated the control panel of the vehicle information system so as to be operable by a vehicle occupant. The display member 36 includes a display block 39 for displaying the information relative to the selected data signal. The data signal within this third described embodiment may originate from within the vehicle's main computer, relative to the operational status of a vehicle's components (e.g. oil pressure, engine temperature, etc.), or from an external signal which the vehicle is equipped to receive, such as an OnStar® or other navigation system, mobile phone, home security, etc.

The apparatus 30 in the embodiment of FIGS. 6-7 scrolls indicia corresponding to the selected data across the display field 39, so long as signals from the vehicle speed sensor 35 indicate that the vehicle speed is within the scrolling range.

Although the present invention has been described herein with respect to a preferred embodiment thereof, the foregoing description is intended to be illustrative, and not restrictive. Those skilled in the art will realize that many modifications of the preferred embodiment could be made which would be operable. All such modifications which are within the scope and spirit of the present invention.

What is claimed is:

1. An electronic apparatus for installing in a vehicle and for selecting and displaying information in a vehicle when installed therein, said apparatus comprising:
a selecting member for selecting a data signal to be displayed;
a display member for visually displaying indicia corresponding to said data signal; and
a controller for controlling the display of said indicia on said display member,
said controller being operable to modify scrolling movement of said indicia across said display member based on vehicle speed.

2. The apparatus of claim 1, wherein the selecting member is operable to select a data signal in response to input from a vehicle occupant.

3. The apparatus of claim 1, wherein said display member further includes at least one display field for electronically displaying indicia.

4. The apparatus of claim 1, wherein said controller is in electronic communication with said selecting member to receive a selected data signal and display indicia corresponding to said selected data signal.

5. The apparatus of claim 1, wherein said controller is operable to selectively display indicia within a display field of said display member in a scrolling sequence when it is informed that vehicle is stationary or moving at a speed within a first speed range.

6. The apparatus of claim 5, wherein said controller is operable to temporarily interrupt the scrolling sequence of displayed indicia when a vehicle is traveling at a speed outside of said first speed range.

7. The apparatus of claim 1, wherein said apparatus further comprises a vehicle audio entertainment unit.

8. The apparatus of claim 1, wherein said apparatus further comprises a vehicle information system, which is operable to monitor vehicle component status.

9. A method of displaying selectively scrolling indicia on a display screen in a vehicle, comprising the steps of:
a) selecting a data signal to be displayed;
b) reading said selected data signal with a controller;
c) displaying said indicia corresponding to said selected data signal on a display member, wherein said indicia are normally displayed in a scrolling sequence;
d) reading a signal from a vehicle speed sensor with said controller, and interrupting said scrolling sequence and displaying a static display when the instantaneous vehicle speed is outside of a specified range.

10. An apparatus for selecting and displaying information in a vehicle when installed therein, said apparatus comprising:
a radio data system (“RDS”) receiver for receiving data signals;
a selecting member for selecting a data signal from said RDS receiver in response to vehicle occupant input;
a display member within said RDS receiver including at least one display field for visually displaying information;
a controller for receiving the selected data signal from said selecting member and translating said selected data signal into indicia displayed on a field within said display member in a selectively scrolling sequence;
said controller being operable to temporarily interrupt said scrolling sequence in response to selected input from a vehicle's speed sensor.

11. The apparatus of claim 10, wherein upon receipt of input from a vehicle's speed sensor corresponding to vehicle movement, said controller disengages the scrolling sequence and displays the indicia within said display field in a static position.

12. A method of displaying selectively scrolling indicia on a display member in a vehicle, comprising the steps of:
a) selecting a data signal;
b) reading said selected data signal with a controller;
c) displaying indicia corresponding to said selected data signal within a display member of an audio entertainment system, wherein said indicia are normally displayed in a scrolling sequence;
d) reading a signal from a vehicle speed sensor with said controller, and interrupting said scrolling sequence and displaying a static display when an instantaneous vehicle speed is within a specified range.

13. An apparatus for selecting and displaying information in a vehicle when installed therein, said apparatus comprising:
a vehicle information system for displaying information relative to the components of a vehicle in electronic communication with said vehicle's central computer;
a selecting member for selecting a data signal from said vehicle information system in response to vehicle occupant input;
a display member within said vehicle information system including at least one display field for visually displaying information;
a controller for receiving the selected data signal from said selecting member and translating said selected data signal into indicia displayed on a field within said display member in a selectively scrolling sequence;
said controller being operable to modify said scrolling sequence based on vehicle speed.

14. The apparatus of claim 13, wherein said controller is operable to display indicia within a display field of said display member in a scrolling sequence when the vehicle is stationary or moving at a speed within a designated speed range.

15. The apparatus of claim 14, wherein said controller is operable to temporarily interrupt the scrolling sequence of displayed indicia when a vehicle is traveling within a predetermined speed range and display said indicia within said display field in a static position.

16. A method of displaying selectively scrolling indicia on a display member in a vehicle, comprising the steps of:
a) selecting a data signal to be displayed;
b) reading said selected data signal with a controller;
c) displaying indicia corresponding to said selected data signal within a display member of a vehicle information system, wherein said indicia are normally displayed in a scrolling sequence;
d) reading a signal from a vehicle speed sensor with said controller to determine an instantaneous vehicle speed;
e) comparing the instantaneous vehicle speed to a predetermined speed range;
f) interrupting said scrolling sequence and displaying a static display if the instantaneous vehicle speed is within a specified range; and
g) repeating steps d-f after a time period has elapsed.

17. An apparatus for selecting and displaying information in a vehicle, said apparatus comprising:
a vehicle including electronic circuitry, a data signal receiver, and a vehicle speed sensor;
a selecting member for selecting a data signal to be displayed;
a display member for visually displaying indicia corresponding to said data signal; and
a controller, in electronic communication with said vehicle's electronic circuitry, for receiving the selected data signal from said selecting member and translating said selected data signal into indicia displayed on a field within said display member in a selectively scrolling sequence;
said controller being operable to modify said scrolling sequence based on vehicle speed.

18. The apparatus of claim 17, wherein said controller is operable to selectively display indicia within a display field of said display member in a scrolling sequence when it is informed that vehicle is stationary or moving faster than a designated speed.

19. The apparatus of claim 18, wherein said controller is operable to temporarily interrupt the scrolling sequence of displayed indicia when a vehicle is traveling outside of a predetermined speed range, and to display said indicia within said display field in a static position.

20. A method of displaying indicia on a display member in a vehicle, comprising the steps of:
a) selecting a data signal to be displayed;
b) reading said selected data signal with a controller input through operation of the selecting member;
c) displaying indicia corresponding to said selected data signal within a display member of a vehicle information system, wherein said indicia are normally displayed in a scrolling sequence;
d) reading a signal from a vehicle speed sensor with said controller and interrupting said scrolling sequence and displaying a static display when the vehicle speed sensor is outside of a specified range.
